(19) United States
(12) Patent Application Publication
(10) Pub. No.: US 2008/0016475 A1
(43) Pub. Date: Jan. 17, 2008

(54) Method, System and Program Product for Automated Transistor Tuning in an Integrated Circuit Design

(76) Inventors: Christopher M. Durham, Round Rock, TX (US); Peter J. Klim, Austin, TX (US); Robert N. L. Krentler, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/457,332

(22) Filed: Jul. 13, 2006

(51) Int. Cl. G06F 17/50

(52) U.S. Cl. 716/2

(57) ABSTRACT

A method of tuning an integrated circuit design includes holding a reference clock signal constant across the integrated circuit design and, while the reference clock signal is held constant, optimizing transistors forming a register within the integrated circuit design and thereafter optimizing transistors forming one or more clock buffers coupled to the reference clock signal.

### BACKGROUND OF THE INVENTION

1. Technical Field

The present invention relates in general to the field of electronic circuit design, and in particular to the utilization of automated transistor tuning tools. Still more particularly, the present invention relates to an improved method, system and program product for tuning transistors in an integrated circuit design.

2. Description of the Related Art

The design of modem digital integrated circuits, which contain millions of transistors, is a complex task. One of the important design steps is optimization, also referred to as circuit tuning. In the tuning step, the optimal size of each transistor in the circuit is determined. Wider transistors are generally capable of handling increased electrical current, which leads to faster circuits and greater power dissipation. However, wider transistors also consume more physical area and place a heavier burden on the previous stage of logic. Determining the optimal size for each transistor yields tremendous benefits, but since an optimal size must be calculated for each individual transistor, the task can be very complex and time consuming.

Traditional optimization of electronic circuits is a manual, iterative, tedious, and error-prone task. In contrast, automated tuning, which utilizes software implementing sophisticated numerical algorithms, improves performance and increases designer productivity. Static circuit optimization implies the determination of optimal transistor and wire sizes, on a static timing basis, while simultaneously taking into account all paths through the logic. The advantages of static optimization include increased designer productivity, since an optimal circuit is automatically determined; higher quality circuits, e.g. faster, smaller, and/or lower power consumption; and the fact that all possible paths through the logic are simultaneously considered.

Current automated transistor tuning tools, such as IBM's EinsTuner™, play a key role in the circuit design process. Automated transistor tuning tools take many constraints, such as robustness, speed, timing constraints, area, input loading, and rise and fall time limits, into account to render practical tuning results. However, current automated transistor tuning tools do have limitations. Specifically, register components are not tunable by transistor-level tuning tools. This limitation is due to the inclusion of local clock buffers, also known as LCBs, inside the macro paths (i.e., schematics) and the register flip-flop and latch cells of electronic circuits. Local clock buffers are typically designed using components from standard libraries that comply with specific loading rules in order to ensure a common clock arrival and clock skew reference among all registers in the circuit. If clock arrival times are not consistent among all registers, problems (e.g., early and late timing) will arise during the operation of the circuit. Consequently, the present invention recognizes that a method and system for tuning register components and optimizing local clock buffers would be a welcome improvement.

### SUMMARY OF THE INVENTION

A method of tuning an integrated circuit design includes holding a reference clock signal constant across the integrated circuit design and, while the reference clock signal is held constant, optimizing transistors forming a register within the integrated circuit design and thereafter optimizing transistors forming one or more clock buffers coupled to the reference clock signal.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2 illustrates a high level block diagram of an integrated circuit design undergoing optimization in accordance with an embodiment of the present invention;

FIG. 3A is a schematic diagram of clock buffers and registers within an integrated circuit design prior to the transistor tuning process according to one embodiment of the invention;

FIG. 3B is a schematic diagram of clock buffers and registers within an integrated circuit design after the transistor tuning process according to one embodiment of the invention;

FIG. 4 illustrates a generic clock waveform, including rising edge time, falling edge time, rising edge slew, and falling edge slew, as used in an embodiment of the present invention; and

FIG. 5 is a high level logical flowchart of an exemplary method of transistor tuning in accordance with one embodiment of the invention.

### DETAILED DESCRIPTION OF AN ILLUSTRATIVE EMBODIMENT

The present invention provides a method, system, and computer program product for tuning register components and optimizing local clock buffers in electronic circuit designs in order to enhance power efficiency and optimize component sizes.

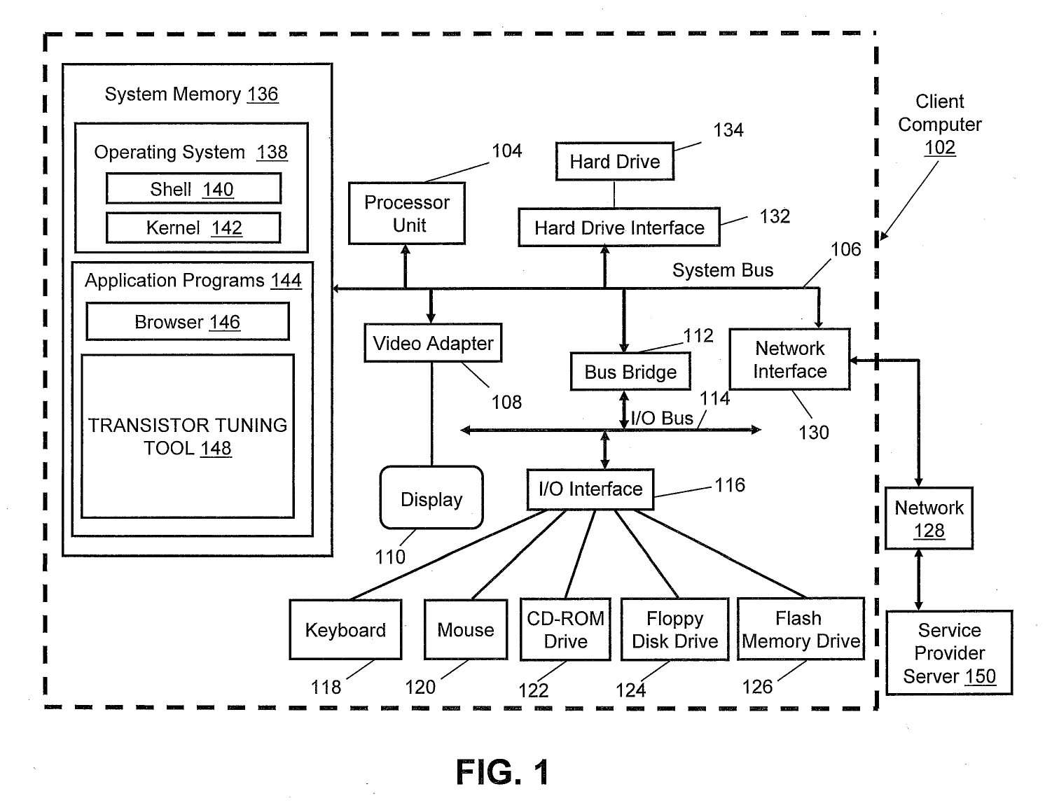

With reference now to FIG. 1, there is depicted a block diagram of an exemplary client computer 102, with which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 150.

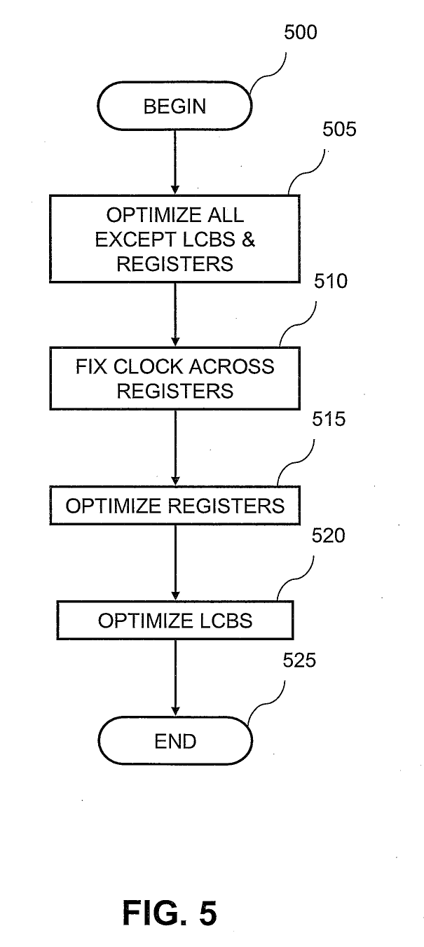

Application programs 144 in system memory 136 also include transistor tuning tool 148. Although illustrated as a single component, in some embodiments transistor tuning tool 148 may be formed of multiple software components. As described further below, transistor tuning tool 148 may be utilized to implement the process depicted in FIG. 5 wholly or in part. In one embodiment, client computer 102 is able to download transistor tuning tool 148 from service provider server 150 shown in FIG. 1, for example, via browser 146. In another embodiment, client computer 102 accesses transistor tuning tool 148 via browser 146. An example of transistor tuning tool 148 that may be utilized in the present invention include EinsTuner, available from IBM Corporation of Armonk, N.Y.

The hardware elements depicted in client computer 102 are not intended to be exhaustive, but rather are representative to highlight certain components that mat be utilized to practice the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

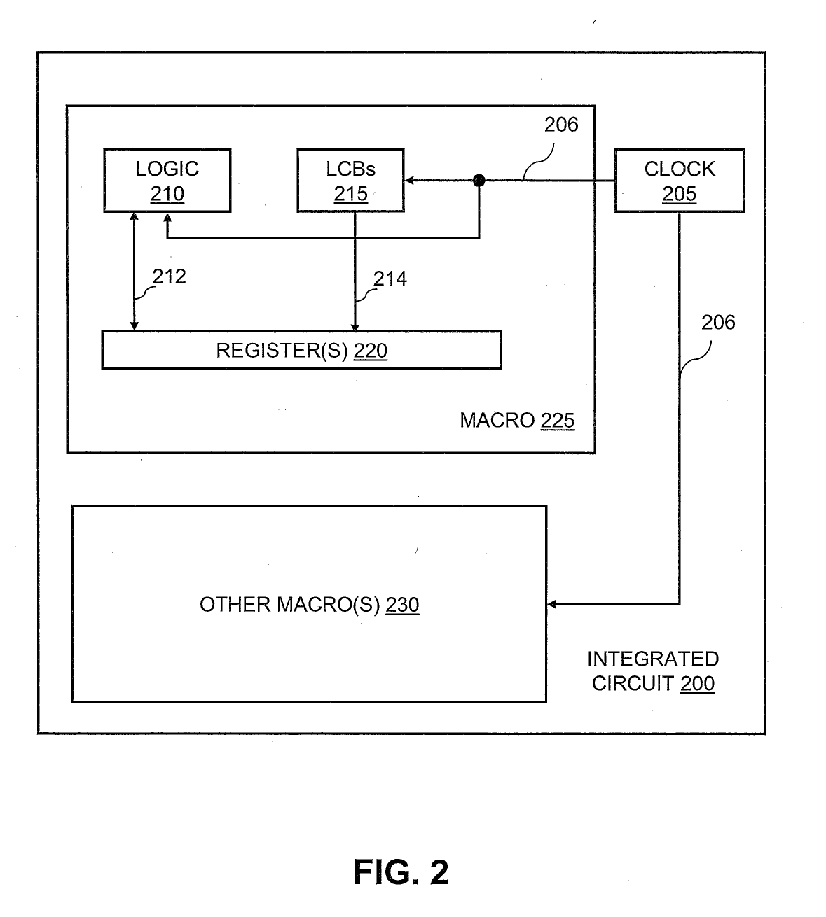

With reference now to FIG. 2, there is depicted a high level block diagram of an exemplary integrated circuit 200 whose design may be tuned by transistor tuning tool 148 in accordance with the present invention. Integrated circuit 200 comprises a substrate (e.g., Si) on which are formed integrated circuitry including a macro 225, one or more other macros 230, and a clock circuit 205 that generates a reference clock signal 206 distributed to macros 225, 230 in order to coordinate their operation. Macro 225 in turn comprises logic 210 for performing one or more desired logical functions, a plurality of local clock buffers (LCBs) 215, and one or more registers 220 that, in response to a local clock signal 214 provided by an LCB 215, buffers data received from logic 210 via functional signals 212.

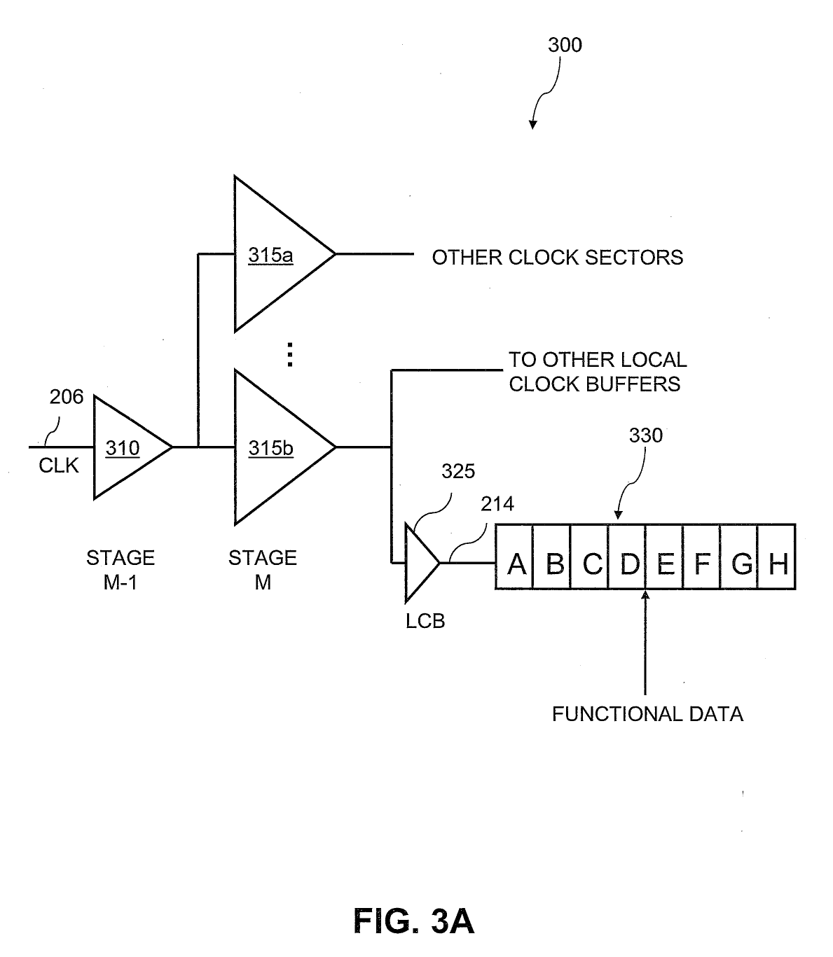

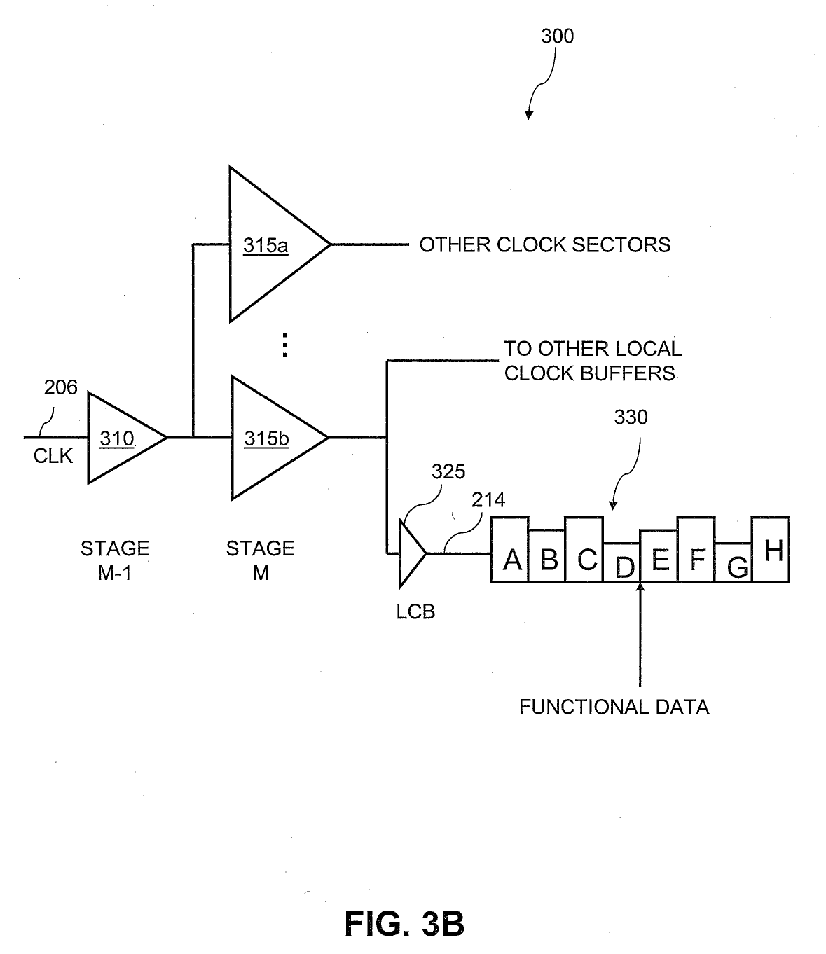

Turning now to FIG. 3A, there is depicted a more detailed block diagram of a typical circuit 300 within macro 225 that contains a local clock buffer (LCB) 325 and register 330. Circuit 300 comprises a portion of a multi-stage clock buffer tree, including an M-1 stage clock buffer 310 and two M^{th} stage clock buffers 315a, 315b. M-1 stage clock buffer 310 receives the reference clock signal 206 as an input and distributes the reference clock to M^{th} stage clock buffers 315a, 315b. M^{th} stage clock buffer 315a distributes reference clock signal 206 to other clock sectors, while M^{th} stage clock buffer 315b distributes reference clock signal to one or more LCBs, including LCB 325 coupled to provide a local clock signal 214 to synchronize the operation of register 330. Register 330 comprises 8 individual bits, labeled A through H.

While circuit 300 is shown having a single M-1 stage clock buffer 310, circuit 300 may instead have a plurality of M-1 stage clock buffers 310. Similarly, while FIG. 3A depicts both M-1 stage clock buffer 310 and M^{th} stage clock buffers 315, circuit 300 may instead have only M^{th} stage clock buffers 315. In yet another embodiment, circuit 300 may comprise one or more stages of clock buffers preceding M-1 stage clock buffer 310, e.g. M-2 stage clock buffer(s).

As can be seen by comparison of FIG. 3B with FIG. 3A, after the design of integrated circuit 200 has been tuned in accordance with the present invention, the size of the transistors comprising each of bits A through H may differ according to the specific power, area, and timing requirements of integrated circuit 200. Consequently, different ones of register bits A-H may have different resulting sizes. In addition, individual clock buffers, such as LCB 325, M^{th} stage clock buffers 315a, 315b, and/or M-1 stage clock buffer 310 may also be resized (e.g., reduced in size) after tuning as a result of the redefined attributes of bits A through H within register 330.

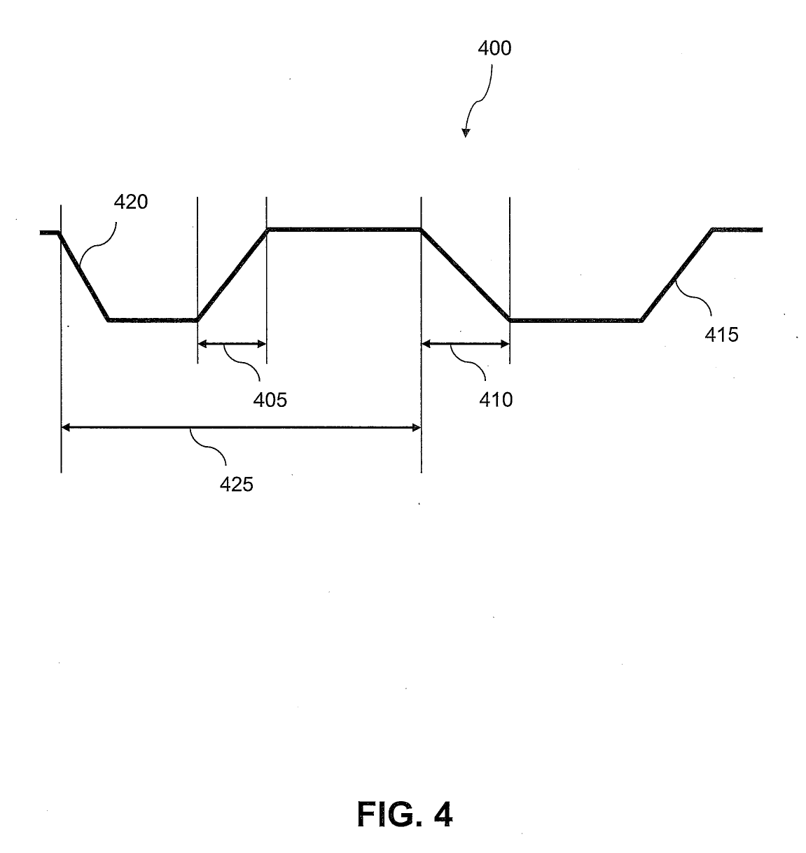

With reference now to FIG. 4, there is depicted a generic waveform 400 of clock reference signal 206 in accordance with the present invention. As depicted, waveform 400 exhibits an oscillation between a minimum voltage and a maximum voltage over a fixed period 425. Waveform 400 may be characterized by at least four additional factors: rising edge time 405, falling edge time 410, a rising edge slew rate, and falling edge slew rate. As depicted, rising edge time 405 is defined as the time required for waveform 400 to transition from its minimum voltage to its maximum voltage. Falling edge time 410 is similarly defined as the time required for waveform 400 to transition from its peak voltage to its minimum voltage. Rising edge slew rate is defined as the maximum rate of change in voltage of waveform 400 in its rising edge 415. Similarly, falling edge slew rate is defined as the maximum rate of decrease in the voltage of waveform 400 in its falling edge 420. The present invention utilizes pattern matching and/or name recognition to ensure that all four factors (i.e., rising edge time 405, falling edge time 410, rising edge slew rate, and falling edge slew rate) that characterize waveform 400 are held constant during the automated tuning of registers 220 as described further below.

Turning now to FIG. 5, there is depicted a high level logical flowchart of an exemplary method of transistor tuning in accordance with one embodiment of the invention. According to this method, the characteristics of reference clock signal 206 are held constant during tuning of registers 220.

The transistor tuning process begins at block 500, for example, in response to a user of computer 102 invoking transistor tuning tool 148, which preferably performs the remainder of the illustrated steps in an automated manner. At block 505, transistor tuning tool 148 optimizes all transistors within the design of integrated circuit 200 except those that implement LCBs 215, such as LCB 325, and registers 220, such as register 330. For example, transistor tuning tool 148 optimizes the transistors forming logic 210. Next, at block 510, transistor tuning tool 148 holds the waveform 400 of reference clock signal 206 constant across the design of integrated circuit 200 via the utilization of pattern matching and/or name recognition. As noted above, the four principle factors (i.e., rising edge time 405, falling edge time 410, rising edge slew rate, and falling edge slew rate) that characterize waveform 400 are held constant. By doing so, common arrival times and signal slews are applied at all register components during tuning, preventing the occurrence of errors arising from early or late signal arrival times for functional signals.

The process then proceeds from block 510 to block 515, which depicts transistor tuning tool 148 optimizing the sizes of the transistors forming registers 220 based on known loading rules and standard design libraries. As shown in FIG. 3B, such optimization can lead to the reduction in size of the transistors forming one or more of bits A-H of register 330. At block 520, transistor tuning tool 148 thereafter optimizes the transistors forming the plurality of clock buffers within the design of integrated circuit 200, including M-1 stage clock buffer 310, M^{th} stage clock buffers 315a, 315b, and LCB 325 utilizing known loading rules based upon newly-optimized registers 220. Finally, the transistor tuning process implemented by transistor tuning tool 148 terminates at block 525 and the attributes of reference clock signal 206 are no longer held constant within the design of integrated circuit 200.

As has been described, the present invention provides a method, data processing system and program product for automated transistor tuning in an integrated circuit design. According to the present invention, a predetermined reference clock waveform is selected to ensure common data arrival times and signal slews at all register components during tuning. In order to create conditions amenable to the tuning of register components, pattern matching and/or name recognition are employed to hold local clock signatures constant. The individual register bits can then be selected from a standard library to optimize the size of each register bit, such that power efficiency is increased. Once register tuning is complete, the output loads of the local clock buffers (LCBs) may subsequently be optimized to complement the power, area, and timing of the newly optimized registers.

While the invention has been particularly shown and described with reference to a preferred embodiment, it will be understood by those skilled in the art that various changes in form and detail may be made therein without departing from the spirit and scope of the invention. For example, while an illustrative embodiment of the present invention has been described in the context of a fully functional computer system with installed software, those skilled in the art will appreciate that the software aspects of an illustrative embodiment of the present invention are capable of being distributed as program code embodied in a program product having any of a variety of forms, and that the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

What is claimed is:

1. A method of tuning an integrated circuit design, said method comprising:
holding a reference clock signal constant across the integrated circuit design; and
while the reference clock signal is held constant:
optimizing transistors forming a register within the integrated circuit design; and
thereafter, optimizing transistors forming one or more clock buffers coupled to said reference clock signal.

2. The method of claim 1, wherein said step of optimizing transistors forming a register comprises individually optimizing each bit within the register, such that at least two bits within the register are differently sized.

3. The method of claim 1, wherein said step of holding the reference clock constant comprises holding a rise time, fall time, rising edge slew rate and falling edge slew rate of the reference clock signal constant.

4. The method of claim 1, and further comprising:
prior to holding the reference clock signal constant, optimizing transistor sizes within a logic circuit of the integrated circuit.

5. A program product comprising:
a signal-bearing medium; and
program code embodied within the signal-bearing medium, said program code including a transistor tuning tool that causes a data processing system to perform a method of tuning an integrated circuit design, including the following steps:
holding a reference clock signal constant across the integrated circuit design; and
while the reference clock signal is held constant:
optimizing transistors forming a register within the integrated circuit design; and
thereafter, optimizing transistors forming one or more clock buffers coupled to said reference clock signal.

6. The program product of claim 5, wherein said step of optimizing transistors forming a register comprises individually optimizing each bit within the register, such that at least two bits within the register are differently sized.

7. The program product of claim 5, wherein said step of holding the reference clock constant comprises holding a rise time, fall time, rising edge slew rate and falling edge slew rate of the reference clock signal constant.

8. The program product of claim 5, wherein the method further comprises:
prior to holding the reference clock signal constant, optimizing transistor sizes within a logic circuit of the integrated circuit.

9. A data processing system, comprising:
a processing unit;
data storage coupled to the processing unit; and
program code embodied within the data storage, said program code including a transistor tuning tool that causes the data processing system to perform a method of tuning an integrated circuit design, including the following steps:
holding a reference clock signal constant across the integrated circuit design; and
while the reference clock signal is held constant:
optimizing transistors forming a register within the integrated circuit design; and
thereafter, optimizing transistors forming one or more clock buffers coupled to said reference clock signal.

10. The data processing system of claim 9, wherein said step of optimizing transistors forming a register comprises individually optimizing each bit within the register, such that at least two bits within the register are differently sized.

11. The data processing system of claim 9, wherein said step of holding the reference clock constant comprises holding a rise time, fall time, rising edge slew rate and falling edge slew rate of the reference clock signal constant.

12. The data processing system of claim 9, wherein the method farther comprises:
prior to holding the reference clock signal constant, optimizing transistor sizes within a logic circuit of the integrated circuit.
